(19) United States
(12) Patent Application Publication
(10) Pub. No.: US 2002/0080095 A1
(43) Pub. Date: Jun. 27, 2002

(54) Multiple flat screen information monitor

(76) Inventor: Rocky O'nan, Henderson, NV (US)

Correspondence Address: ROBERT M. SPERRY, ESQ., 23390 OSTRONIC DRIVE, WOODLAND HILLS, CA, 91367, US

(21) Appl. No.: 09/729,682

(22) Filed: Dec. 5, 2000

Related U.S. Application Data
(60) Provisional application No. 60/204,533, filed on May 16, 2000.

(51) Int. Cl. G09G 1/06

(52) U.S. Cl. 345/10

(57) ABSTRACT

A computer monitor having plurality of computer monitor screens which are releasably attached to an existing monitor and are moveable between a stored position and a useful position.

### RELATED CASES

This invention is disclosed in my copending Provisional Patent Application, Ser. No. 60/204,533, filed May 16, 2000 and now ______.

### FIELD OF THE INVENTION

This invention relates to electronic equipment and is particularly directed to improved flat screen monitors having a plurality of screens each movable between a stored position and a useful position.

### PRIOR ART

It is well known that computers and other electronic equipment can readily provide more information than can be displayed on a single monitor screen. Moreover, it is becoming increasingly common to combine electronic devices, such as television, telephone, internet and computer displays and multimedia devices. Thus, it is common practice to provide multiple picture-in-picture capability or to minimize/maximize pages in order to be able to compare information contained on two screens. However, these techniques are cumbersome and time-consuming to operate. Another way to accomplish this is to provide multiple monitors, however, this is expensive and occupies considerable desk space, which is always needed for something else. Unfortunately, no other alternatives are currently available.

### BRIEF SUMMARY AND OBJECTS OF INVENTION

These disadvantages of the prior art are overcome with the present invention and vastly more screen space is made immediately available at minimal cost and without occupying additional desk space.

These advantages of the present invention are preferably attained by providing a plurality of monitor screens which are releasably attached to an existing monitor and are moveable between a stored position and a useful position.

Accordingly, it is an object of the present invention to provide substantially more monitor screen space.

Another object of the present invention is to provide a substantially more monitor screen space without occupying additional desk space.

A further object of the present invention is to provide substantially more monitor screen space without requiring the user to switch between multiple screens.

An additional object of the present invention is to provide substantially more monitor screen space without requiring the user to employ picture-in-picture techniques.

Another object of the present invention is to provide a plurality of flat monitor screens simultaneously.

An additional object of the present invention is to provide a plurality of flat monitor screens simultaneously without occupying excessive desk space.

A specific object of the present invention is to provide a monitor having plurality of flat monitor screens which are releasably attached to an existing monitor and are moveable between a stored position and a useful position.

These and other objects and features of the present invention will be apparent from the following detailed description, taken with reference to the figures of the accompanying drawing.

### BRIEF DESCRIPTION OF THE DRAWING

FIG. 1 is an isometric view of a monitor embodying the present invention shown with an auxiliary screen in the stored position;

FIG. 2 is an isometric view of the monitor of FIG. 1 with an auxiliary screen shown in a useful position;

FIG. 3 is an isometric view of the computer of FIG. 1 showing three auxiliary screens in useful positions; and

FIG. 4 is a front view showing one of the auxiliary screens of FIG. 3 removed for use apart from the monitor of FIG. 1.

### DETAILED DESCRIPTION OF THE INVENTION

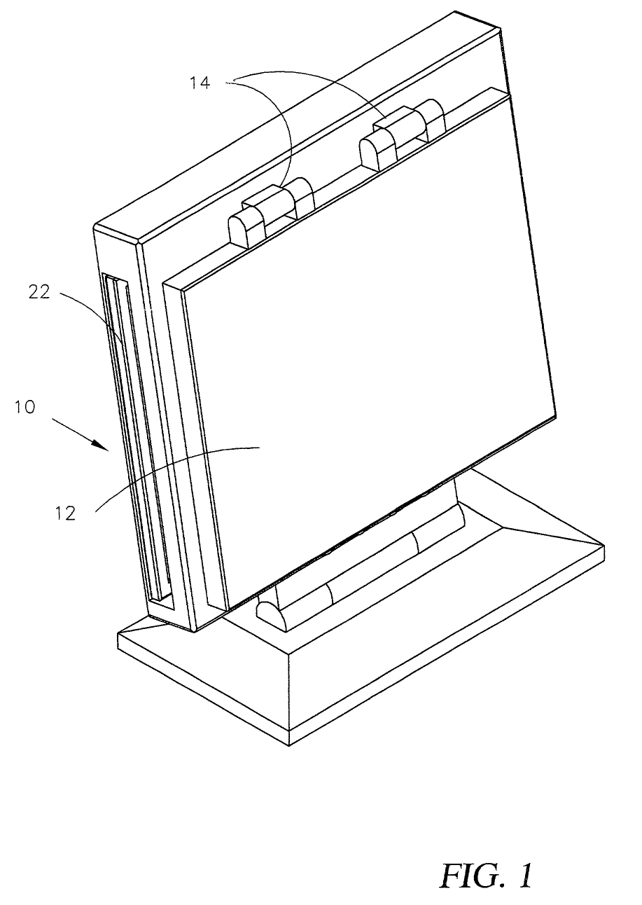

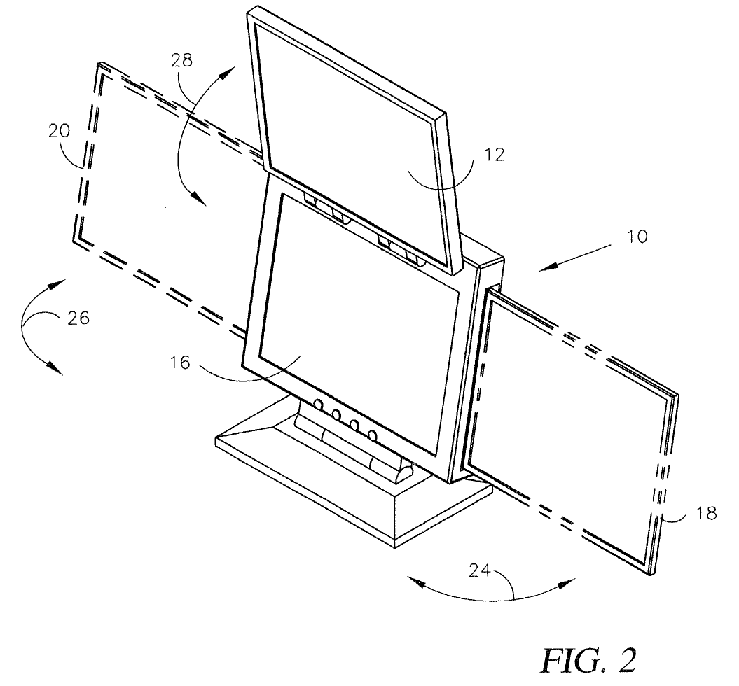

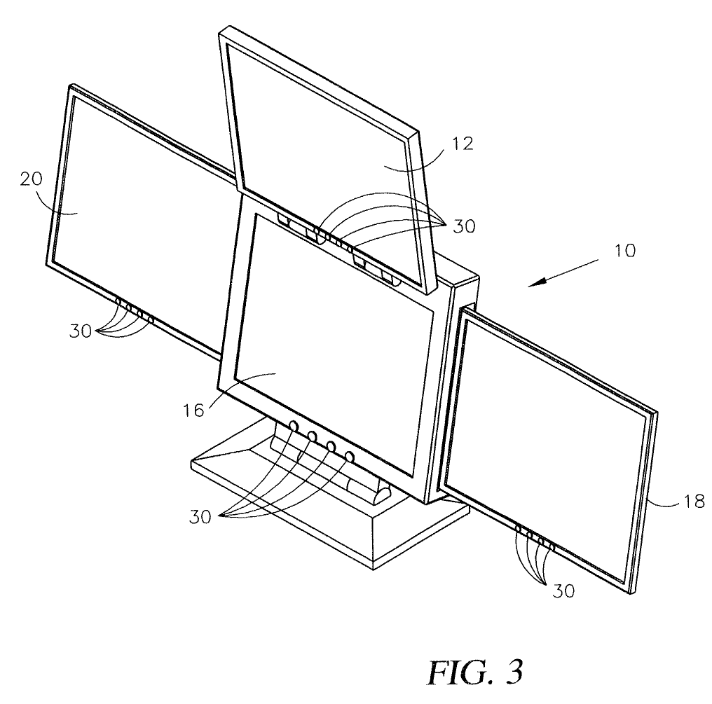

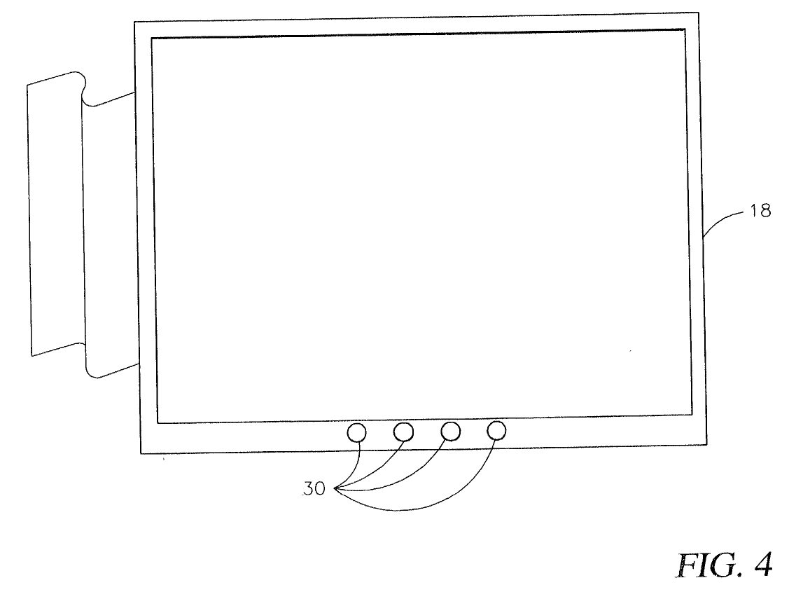

In that form of the present invention chosen for purposes of illustration, FIG. 1 shows a flat screen monitor, indicated generally at 10, having an auxiliary screen 12 pivotally secured, as seen at 14, adjacent the upper edge of the monitor 10 and folded downward to cover the main screen 16 of the monitor 10. This is the stored position for the auxiliary screen 12. For use, the auxiliary screen 12 will be pivoted upward to stand above the main screen 16, as seen in FIG. 2. Additional auxiliary screens 18 and 20 are stored in recesses 22 behind the main screen 16 and are moveable between the stored positions, as seen in FIG. 1 and the extended positions seen in FIG. 3. Also, as seen in dotted lines in FIG. 2, the auxiliary screens 12, 18 and 20 are pivotally mounted and are moveable to a variety of positions, as indicated by arrows 24, 26 and 28. Finally, as seen in FIG. 4, the auxiliary screens 12, 18 and 20 may, if desired, be detached from the main monitor 10 for use independently. As seen in FIG. 3, control buttons 30 may be provided on the frames of each of the screens 12, 16, 18 and 20 to allow the user to control the functions of the respective one of the screens 12, 16, 18 and 20. Furthermore, if desired, the screens 12, 16, 18 and 20 may include touch controls to enable the user to perform various functions by simply touching the screen.

In use, auxiliary screen 12, when folded over the main screen 16, serves to protect both the main screen 16 and the auxiliary screen 12 from dust, fingerprints, etc. However, when desired, the auxiliary screen 12 may be raised to the position seen in FIG. 2 to allow use of either or both of the screens 12 and 16 as a multi-screen array. If the user wishes to display material on the auxiliary screen 12, the user simply strikes a key on an appropriate keyboard, not shown, to activate the auxiliary screen 12. Similarly, if the user wishes to employ auxiliary screens 18 or 20, they simply slide the screen 18 or 20 out to its extended position, as seen in FIG. 3, and strike an appropriate key on the keyboard to activate the auxiliary screen 18 or 20. As indicated by arrows 24, 26 and 28, the auxiliary screens 12, 18 and 20 may be positioned substantially as desired to suit the needs or desires of the user. Finally, if desired, any of the auxiliary screens 12, 18 or 20 may be detached from the main monitor 10, as seen in FIG. 4, for use independently.

Obviously, numerous variations and modifications can be made without departing from the spirit of the present invention. Therefore, it should be clearly understood that the forms of the present invention described above and shown in the figures of the accompanying drawing are illustrative only and are not intended to limit the scope of the present invention.

What is claimed is:

1. A computer monitor comprising:
a main screen, and
at least one auxiliary screen mounted on said monitor and moveable between a stored position and a useful position.

2. The monitor of claim 1 wherein:
said auxiliary screen is pivotally mounted adjacent one side of said main screen.

3. The monitor of claim 2 wherein:
said auxiliary screen is mounted adjacent the top of said main screen.

4. The monitor of claim 2 wherein:
said auxiliary screen covers said main screen when in said stored position.

5. The monitor of claim 1 wherein:
said monitor is formed with at least one recess behind said main screen, and
an auxiliary screen is stored in said recess and is movable out of said recess to a useful position.

6. The monitor of claim 1 whereon:
said auxiliary screen is adjustable to a desired position.

7. The monitor of claim 1 wherein:
said auxiliary screen is detachable from said monitor and is useful independently of said monitor.

8. The monitor of claim 1 wherein:
said main screen and said auxiliary screen carry control buttons to enable a user to control desired functions thereof.

9. The monitor of claim 1 wherein:
said main screen and said auxiliary screen contain touch controls.
